(19) United States
(12) Patent Application Publication
(10) Pub. No.: US 2012/0154151 A1
(43) Pub. Date: Jun. 21, 2012

(54) DESICCANT CANISTER AND EAS RF TAG

(76) Inventors: Genevieve Kuhn, Albuquerque, NM (US); Alicia Armijo, Los Lunas, NM (US)

(21) Appl. No.: 13/239,434

(22) Filed: Sep. 22, 2011

Related U.S. Application Data
(60) Provisional application No. 61/386,911, filed on Sep. 27, 2010.

(51) Int. Cl. G08B 13/14; B65D 81/26

(52) U.S. Cl. 340/572.1; 206/204

(57) ABSTRACT

An electronic article surveillance system is disclosed. The system of the present invention has a moisture-sensitive article placed within a canister having a non-static desiccant material and an activated electronic article surveillance radio frequency (EAS RF) device. The EAS RF device is placed between a Generally Regarded as Safe qualified label and a release liner which is applied to the canister. The system also has an EAS RF detector which monitors an associated interrogation zone for a signal from the activated EAS RF device thereby activating an alarm.

### CROSS REFERENCE TO RELATED APPLICATIONS

This application claims priority to U.S. Patent Application 61/386,911 filed on Sep. 27, 2010, which is incorporated herein in its entirety by reference.

### BACKGROUND

This application includes embodiments pertaining to a desiccant canister and electronic article surveillance device, system and/or method. The transport and movement of pharmaceuticals and/or nutraceuticals through commerce raises a couple of concerns for the different entities that take part in the exchange. For manufacturers, ensuring the potency and efficacy of their product is important to sustaining profitability and positive relations with the consuming public, from the wholesalers down to the end-user. Providing consumers with confidence that the item purchased has been protected from external tampering and internal destruction is invaluable. Additionally, the expense of the products have made the products popular targets for theft and black-market dealings, therefore, stop-loss prevention is an equally high priority concern. Thus, it is desirable to have a system or device(s) that addresses each of these concerns.

For example, if pharmaceuticals, vitamins or dietary supplements, or other nutraceuticals, are exposed to moisture, the composition may be altered and its efficacy may be reduced. In some instances, moisture exposure is so severe that the product cakes or is otherwise destroyed, and thereby rendered useless. The shortened shelf-life or reduced efficacy of these products increase the costs to pharmacies and consumers, and may damage the reputation of the pharmaceutical or nutraceutical brand as being relatively ineffective or weak.

One method for removing moisture from the packaging of a pharmaceutical or nutraceutical is through the use of desiccant containers, such as a desiccant bag or a desiccant canister. The desiccant containers may be filled with desiccant material for absorbing or adsorbing moisture from the surrounding environment, utilizing such material(s) as clay compositions and/or silica gel. The desiccant canisters may also include odor-absorbing materials such as activated carbon or other similarly-acting fills. Separately or in combination, the desiccant(s) and/or odor-absorbing material(s) are used to extend the usable-life of such items or articles as pharmaceuticals, nutraceuticals, as well as diagnostic, medical, and/or dental products.

For stop-loss prevention, the application of electronic article surveillance (EAS) devices to the packaging of products shipped to wholesalers and retailers is one means by which to deter theft of these high-value products. However, if a thief can remove the targeted product from its packaging before leaving the monitored area, then the EAS device(s) does not prevent theft as desired. As a result, the use of EAS devices more deeply embedded with the targeted product has emerged as another attempt to frustrate would-be thieves.

In one non-exhaustive example of related technology attempting to address these two concerns, U.S. Pat. No. 6,977,589 (assigned to Desiccare) discloses a desiccant bag for adsorbing moisture from a surrounding space in a packaged product and includes on its inner surface an EAS or EAS tag, which enables detection of stolen products by theft or shoplifter detectors. The EAS tag is not visible from the outside of the bag or product package, and is thus unlikely to be detected and removed by a thief. The bag may also be printed with an invisible message or taggant containing information such as source or intended destination.

Another non-exhaustive example of related technology includes U.S. 2010/0000960 (Anderson), which discloses a dosing cap engagable to and removable from a prescription bottle, the dosing cap having absorbent material and a tracking element, such as a bar code, nano-chip, radio frequency identification (RFID) device, or other tracking element. The tracking device transmits data from the product to remote computers or systems for tracking of individual units of product. Collectively, the data yields valuable information such as quantity of units stocked, units sold, frequency of unit sales, and other related information.

Another non-exhaustive example of related technology includes EP 1,787,917 (Portier), which discloses a product container having a desiccant element and a transponder embedded in a hollow space of the container. In particular, the desiccant element and transponder are positioned within the cover of the product container. The desiccants are described as being a powder or granulate. The transponder includes an RFID chip and an antenna.

Accordingly, a need remains for a device, system, and/or method that removes moisture from the surrounding environment and further provides a stop-loss prevention component to reduce and discourage theft of the targeted and protect product(s). Certain embodiments of the invention represent advancement and improvement in the technology of desiccant devices and theft-deterrent devices.

### SUMMARY

Certain embodiments of the invention include an EAS RF tag applied to a desiccant canister.

Certain embodiments of the invention include an EAS RF system comprising an EAS RF tag applied to a desiccant canister, the canister embedded with at least one moisture sensitive article or product, and at least one transmitter-receiver system positioned at or near the exit of a retail establishment.

Certain embodiments of the invention include a process for monitoring moisture-sensitive article(s) utilizing an EAS RF tag applied to a desiccant canister that is embedded with the moisture sensitive article(s).

Certain embodiments of the invention include an anti-theft desiccant canister comprising: a cylindrical body, a non-static forming desiccant contained within the canister, and an electronic article surveillance radio frequency (EAS RF) device that is embedded within a GRAS qualified label that is applied to the outside of the canister.

Certain embodiments of the invention include a kit comprising: a container retaining at least one moisture-sensitive article, a canister comprising a non-static desiccant material and an activated electronic article surveillance radio frequency (EAS RF) device, and the EAS RF device disposed between a GRAS qualified label and a release liner, the label and/or EAS RF device applied to the canister, and the EAS RF device emitting an RF signal for detection.

Certain embodiments of the invention include an electronic article surveillance system comprising: at least one moisture-sensitive article, a canister comprising a non-static desiccant material and an activated electronic article surveillance radio frequency (EAS RF) device, the device disposed between a GRAS qualified label and a release liner, the label applied to the canister, the canister embedded with the at least one moisture-sensitive article, and an EAS RF detector monitoring at least one associated interrogation zone for a signal from the activated EAS RF device.

Certain embodiments of the invention include an electronic article surveillance system comprising: at least one moisture-sensitive article, a canister comprising a non-static desiccant material and an activated electronic article surveillance radio frequency (EAS RF) device, the device disposed between a GRAS qualified label and a release liner, the label applied to the canister, the canister embedded with at least one moisture-sensitive article, at least one gate comprising a transmitter and receiver, the transmitter producing a signal across an interrogation zone, the receiver detecting the device within the interrogation zone and generating an alarm message.

Certain embodiments of the invention include a process for monitoring moisture-sensitive articles, the process comprising the steps of: embedding a desiccant canister within a container retaining the moisture-sensitive articles, the canister comprising a non-static desiccant and an activated electronic article surveillance radio frequency (EAS RF) device having a GRAS qualified label and a release liner, enclosing the articles and canister within the container, establishing an interrogation zone adjacent at least one exit, transmitting a signal across the interrogation zone, and detecting an active EAS RF device entering the interrogation zone.

### BRIEF DESCRIPTION OF THE DRAWINGS

FIG. 1 is a front or side view of a desiccant canister;

FIG. 2 and FIG. 3 are various sectional views of FIG. 1;

FIGS. 4a, 4b, and 4c are different embodiments of the various configurations for the pinholes envisioned;

FIG. 5 is a top view of an RF tag with the label;

FIG. 6 is a top view of an RF tag with the label provided;

FIG. 7a is a side view of the elements of a tag device; FIG. 7b is a side view of the elements of a tag device provided with more detail;

FIG. 8 is a depiction of multiple tags arranged on a release liner sheet;

FIG. 9 is a depiction of a pair of electronic article surveillance gates or pedestals used for detecting theft of articles; and

FIG. 10 is a side view of one embodiment of an antenna that may be used herein.

### DESCRIPTION OF THE EMBODIMENT(S)

All the materials used for construction or manufacture of the various elements or components described below that either contact or may come within close proximity to food or drugs must be compliant with the Food and Drug Administration's (FDA) guidelines. In accordance with the FDA's regulations, materials or items added to a food or drug is considered an additive that must satisfy the requirements as a Generally Recognized As Safe (GRAS) material. Further information concerning GRAS items and requirements may be reviewed at: http://www.fda.gov/Food/GuidanceComplianceRegulatoryInformation/GuidanceDocuments/FoodIngredientsandPackaging/ucm061846.htm#Q1 which is incorporated herein by reference. As used herein, the term “antistatic” includes the use of a material, property, or procedure, or a combination thereof, that disperses or inhibits the accumulation of static charges on textiles, phonograph records, paper products, or other articles of manufacture that may be susceptible to static charges. As used herein, the term “dissipative” includes a material, property, or procedure, or a combination thereof, that scatters, disperses, or dispels a static charge in various directions, or otherwise depletes an accumulated static charge from an article of manufacture.

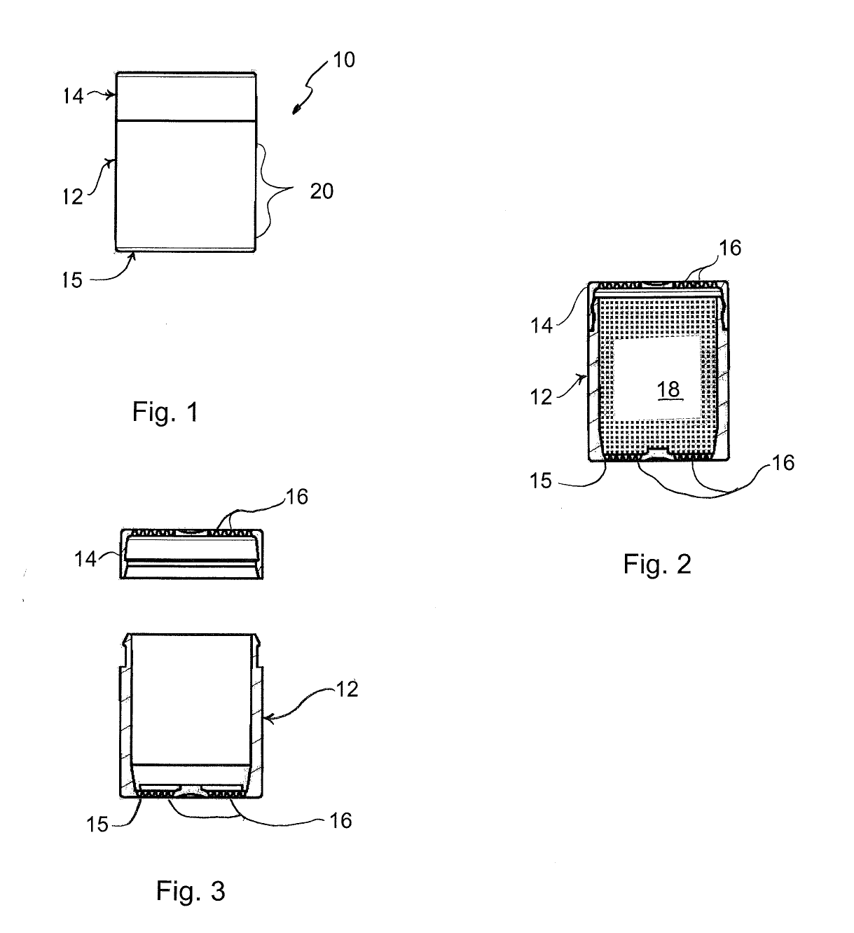

As depicted in FIG. 1 through FIG. 3, a desiccant canister 10 is disclosed and described. The canister 10 comprises a canister body 12 that internally retains desiccant material(s) 18 and externally receives an applied EAS device 20. In such an arrangement, the canister 10 absorbs or adsorbs one or more contaminants (e.g. moisture) from the surrounding environment, while also serving as an embedded EAS device for theft-deterrent. The canister 10 with the applied EAS device 20 may be embedded within a defined area and a generally non-breachable region of the product packaging.

The canister body 12 comprises a polygonal form, which may include cylindrical, orthogonal, or other polygonal forms. The polygonal form is adaptable for use with the insertion equipment utilized by one or more entities. Presently, the most often used insertion equipment utilizes canisters and canister bodies having a cylindrical form. As but one example, a cylindrical body 12 is depicted. The body 12 includes an internal volume for housing and retaining desiccant material 18 and/or other desirable material(s) (e.g. odor-absorbing material). The body 12 may include a cover 14 engaging the opened end of the body 12. The cover 14 may be coupled to the body 12 by a snap-lock mechanism (depicted in FIGS. 2 and 3), by threaded engagement, or other similar couplings or connections. At least one pinhole 16 traverses the cover 14 allowing the contaminant(s) to contact or engage the retained desiccant material(s) 18. It is envisioned that other embodiments may include multiple pinholes 16 placed in multiple locations to further facilitate contact or communication between contaminant(s) and desiccant material(s) 18. It is further envisioned that other embodiments may include one or multiple pinholes 16 formed in the cover end and the opposing end of the canister body 12 (as depicted in FIGS. 2 and 3 and denoted as reference character 15), respectively.

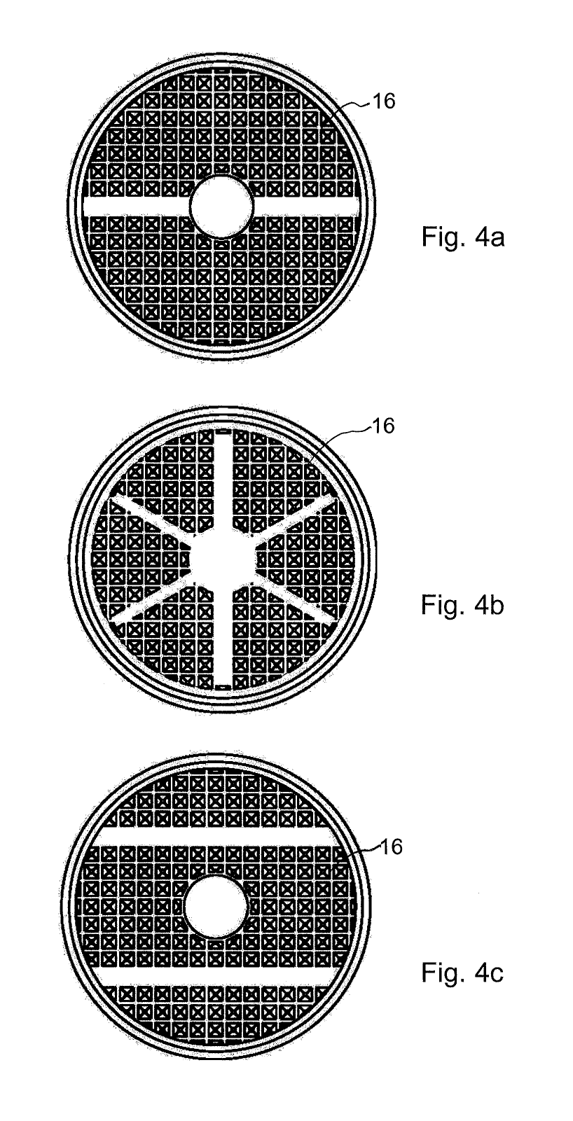

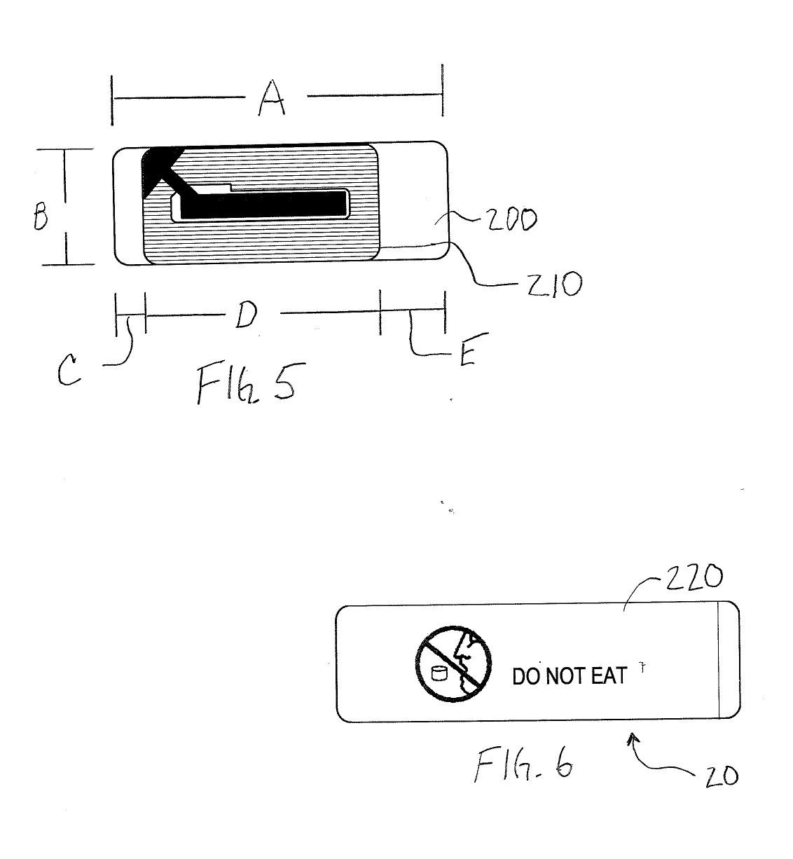

FIG. 4a through 4c depicts several embodiments of the pinholes 16 arranged in the cover 14 and/or the opposing end 15 to the cover 14.

The canister body 12 and cover 14 may be manufactured from a variety of materials, including thermoplastic compositions such as high density polyethylene (HDPE), low density polyethylene (LDPE), polypropylene (PP), and other similar thermoplastic compositions. It is envisioned that a composition having high tensile strength is desired to provide the durability and reusability wanted for such an article. It is further envisioned that a combination or sub-combination of materials and properties recited above may be used in the construction of the body 12 and/or cover 14. It is further envisioned that one or more colorants may be utilized for providing color to the body 12 and/or cover 14.

In another embodiment, a permeable membrane may be incorporated into the structure of the canister, wherein the end(s) 14 and/or 15 comprise a single large aperture through which contaminant(s) may engage the desiccant material retained in the canister. In such an arrangement, a permeable membrane may set adjacent to the single large aperture, and may be either superjacent or subjacent to the aperture. In an embodiment in which both ends 14 and 15 have a single large aperture, a permeable membrane may be positioned at each end adjacent to the respective apertures. The membrane(s) is/are permeable to gas or vapor, but otherwise inhibits ingress by solid(s) and/or liquid(s) material(s) into the canister body 12, as well inhibiting egress of the desiccant material(s) 18 out from the canister body 12, respectively.

In one embodiment, the desiccant material 18 may comprise clay compositions, such as phyllosilicates that include bentonite or montmorillonite. Other embodiments may include desiccant material(s) 18 comprising molecular sieve solid(s). Additionally, other embodiments may include desiccant material(s) 18 comprising compositions or combinations of compositions that inhibit or retain a low static electricity charge. It is envisioned that combinations and sub-combinations of materials, such as a mixture of a clay composite, molecular sieve, odor-absorbing material, and/or a low static electricity promoter may be used as the fill within the canister body 12.

It is envisioned that under normal packaging conditions, the desiccant material 18 is a high moisture adsorbing composition capable of adsorbing 20% to 80% relative humidity. The phyllosilicate materials (e.g. bentonite or montmorillonite) are at least one composition that provides such capabilities.

In one embodiment, a moisture adsorbing material may be selected for insertion into a canister 10 (or a plurality of canisters for mass production). The material may be selected from phyllosilicates and/or molecular sieve solids. As but one example, bentonite may be used, wherein approximately 3 grams of bentonite and/or a mixture of bentonite and additional material(s) may be inserted into the canister(s) 10. Several dimensions are envisioned for scaling among varying container sizes available and in use, including the larger containers used for distribution of pharmaceuticals and nutraceuticals to pharmacies and retailers, as well as containers distributed to the customer in a typical transaction. Additionally, the canister(s) 10 may be designed to fit within insertion devices for pharmaceuticals and/or nutraceuticals of alternative dimensions, as well as alternative polygonal forms as may develop.

Before the material 18 is inserted into the canister body 12, the material 18 engages an antistatic agent or antistatic device to remove static electricity build-up. Thereafter, a plurality of canister bodies 12 may be packaged in an antistatic bag or other similar article to inhibit further or future build-up of static electricity in the material 18. Inhibiting excessive or uneven static electricity build-up prevents the radio frequency element in the EAS device 20 from becoming disabled or damaged, thereby preserving the effectiveness of the EAS device 20 and associated EAS system.

In one embodiment, the EAS device 20 comprises a radio frequency (RF) tag that emits a wireless radio frequency in a range between 1.75 MHz and 9.5 MHz. The RF tag has an antenna comprising a resonant circuit, or a tuned circuit, which emits an electronic signal at a frequency within the range noted above (1.75 MHz-9.5 MHz). Current EAS RF systems operate at a radio frequency of about 8.2 MHz, although other frequencies are envisioned within the aforementioned range. The resonance frequency (or resonant frequency) generated by the antenna of the RF tag is detectable by a detection device or system, which will generate an alarm signal in response to detection of the resonance frequency. More particularly, each activated EAS device 20 may be detectable by a transmitter and receiver system erected at the exit(s) of an establishment (generally depicted in FIG. 9). The transmitter-receiver system is usually a single gate or pedestal or a series of gates or pedestals comprising antenna that transmit a pulse signal or continuous sweep signal in a range that is similar to that of the EAS RF tag and across a defined area, usually referred to as an interrogation zone. For example, in an 8.2 MHz tag and system, the gate(s) emit the pulse or continuous sweep signal in a range of approximately 7.4 MHz and 8.8 MHz, with the pulse or sweep signal detecting the resonance frequency emitted by the RF tag within the EAS device (−8.2 MHz). If the gate signal detects the resonance frequency of an active (non-deactivated) RF tag, the system generates an alarm and/or signal that alert personnel that an active tag has entered the interrogation zone. From there, personnel may ascertain the nature of the alarm, whether it is an attempted theft, a false alarm, or a deactivation mistake at point of sale.

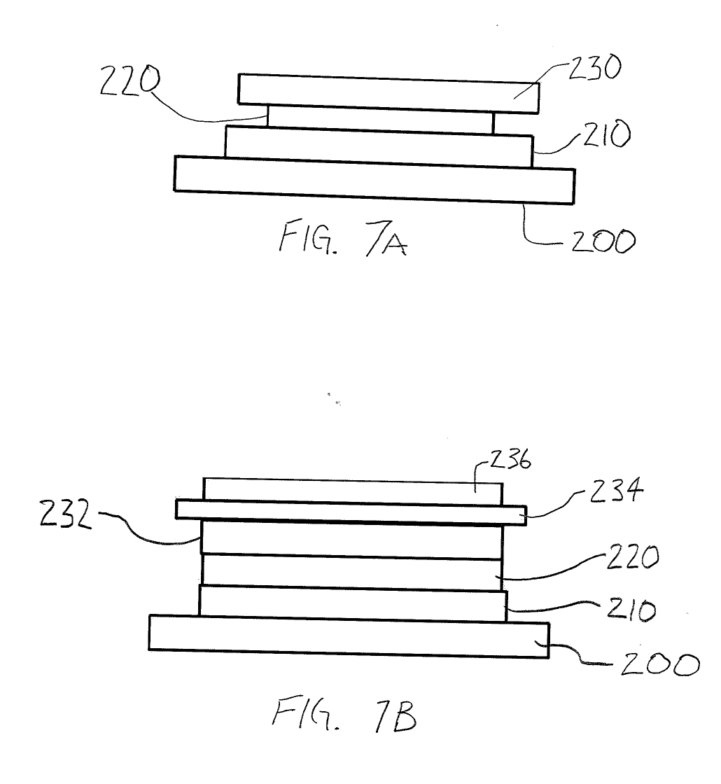

One example of the physical structure and arrangement of an RF tag element within device 20 is depicted in FIG. 5 through FIGS. 7a and 7b. The tag may comprise a release liner 200, a first layer 210, an antenna 220, and a second layer 230, as depicted in FIG. 7a. The details of each element are exaggerated to depict the arrangement and configuration, but are not drawn to scale. In FIG. 7b, a more detailed embodiment is depicted comprising a release liner 200, a first layer 210 comprising an adhesive 212, an antenna 220, and a second layer 230 comprising an adhesive 232, a label 234, and a varnish or external coating 236.

In one embodiment, the release liner 200 comprises an antistatic or static dissipating substrate or material to inhibit static electricity build-up near the RF tag and the desiccant material 18 in the canister body 12. When the label/tag is applied to the canister body 12, the release liner 200 is separated from the label/tag so that the adhesive dispersed across the label/tag may contact and engage the body 12 surface. The release liner 200 may comprise a high-gloss sticker paper or other commercially available material (resisting approximately 8.5 kV of static electricity) that allows the first layer 210, the antenna 220, and the second layer 230 to be adhesively coupled to the release liner 200, but also allows the first layer 210, the antenna 220, and the second layer 230 to easily separate from the release liner 200 for application to the surface of an article, such as the canister(s) 10 described herein during an industrial high-speed label application process.

The first layer 210 may comprise a releasable adhesive material, therefore the release liner 200 and the first layer 210 may be temporarily coupled together. It is envisioned that the first layer 210 may further comprise an additional sub-layer or sub-layers, including the use of a paper or other similar material for bounding or enclosing the antenna 220 along its lower surface, if desired, as well as the use of an antistatic or static dissipating coating or varnish applied thereto. The antenna 220 is intermediately disposed between the release liner 200 and the second layer 230.

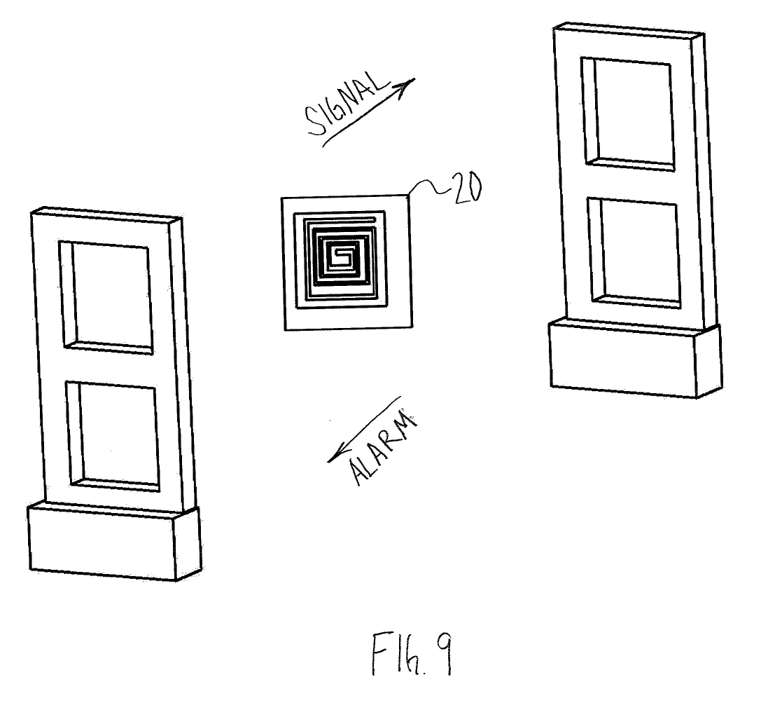

As depicted in FIG. 10, the antenna 220 may comprise a variety of configurations and/or arrangements. One non-exhaustive example may include an antenna 220 comprising a substrate 225 to which a coil 224 and one or more capacitor plates 226 are applied thereto. The capacitor plates 226 may be arranged to reside on opposing surfaces of the substrate 225.

The second layer 230 may comprise a paper label that is an FDA-GRAS compliant material for articles in proximity or contact with ingestible items (e.g. food, pharmaceuticals, nutraceuticals). In one embodiment, the label comprises a compliant paper or paper-like material. The label generally comprises material that is non-toxic as applied to ingestible items, and further comprises material that inhibits transfer of printed ink or dye from the label to the items. For example, as an additional but separate sub-layer of the second layer 230, a clear coating or a varnish may be applied over the label to protect any ink or indicia applied to the visible surface of the label. The coating or varnish prevents the ink or indicia from leeching into the canister and/or onto the pharmaceutical(s) or nutraceutical(s) stored in the canister. The release liner 200 and the second layer 230 enclose the antenna 220 therebetween, thereby protecting the functional component of the RF tag device 20. Once applied to an article, such as a canister, the antenna 220 is disposed between the second layer 230 and the exterior surface of the article (e.g. canister), thus the antenna 220 is protected on both sides from exposure and incidental contact with foreign material(s) or body(ies).

After the first layer 210, antenna 220, and second layer 230 are assembled, or alternatively, after they are adhesively coupled to the release liner 200, the assembled components may be die-cut to the appropriate shape or configuration.

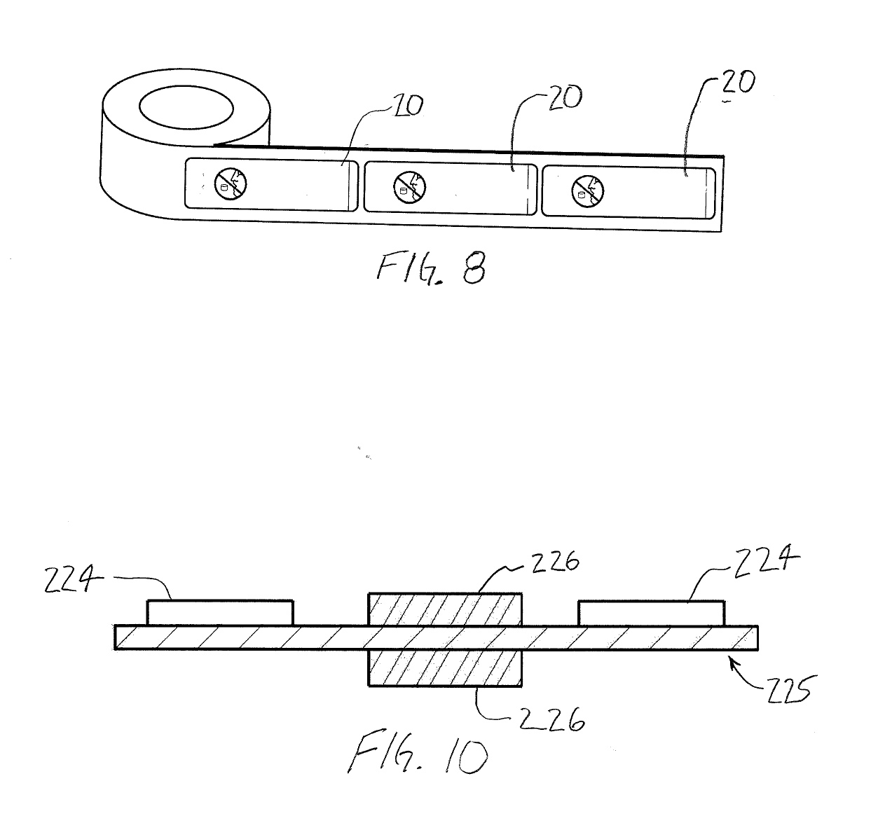

As depicted in FIG. 8, the RF tag 20 is provided on a roll or sheet in which adjacent tags 20 are aligned end-to-end (horizontally) along the roll, rather than top-to-bottom (vertically) as is customary. The horizontal alignment of adjacent tags 20 allows for automated high-speed application of each tag 20 to a canister body 12 and its exterior surface.

In one embodiment, an electronic article surveillance (EAS) system may be arranged and configured according to the combination(s) and sub-combination(s) of elements and components recited above. For example, an EAS system may comprise at least one moisture-sensitive article or product (e.g. quantity of pharmaceuticals dispensed by pharmacy), a canister 10 comprising a non-static desiccant material 18 and a radio frequency emitting EAS RF tag 20. The active element of the tag 20 may be a device 220 (e.g. antenna) disposed between a GRAS qualified label and the release liner 200, the label/tag applied to the canister, the canister embedded with at least one moisture-sensitive article, and an EAS RF detector monitoring at least one associated interrogation zone for a signal from the activated EAS RF tag.

It is envisioned that the EAS component of the embodiments described above may comprise a radio frequency identification (RFID) and associated elements. RFID and associated technology allow for enhanced storage and retrieval of particular data or information desired by the user(s). An RFID tag may include an antenna similar to that of a RF tag, however, the RFID may also include a microchip or other sophisticated circuitry to allow for storage and retrieval of data. The RFID tag may also include an internal battery, or means for using energy from the system as a battery to transmit information through radio wave generation to a reader or other comparable component. The microchip, antenna, and/or battery may be enclosed by plastic, silicon, glass, or another suitable material. The RFID tag may comprise an active tag, a semi-passive tag, or a passive tag.

Other tags and tag configurations are envisioned, including tags that operate in frequency ranges higher than the range previously disclosed (e.g. 1.75 MHz and 9.5 MHz), such that a radio frequency tag may operate in the 10 MHz to 15 MHz range, including the resonance frequency of approximately 13.56 MHz for RFID. In addition, tags may be conformed to operate in the ultra high-frequency range of 850 MHz to 960 MHz.

In another embodiment, an EAS system may comprise at least one moisture-sensitive article or product (e.g. quantity of pharmaceuticals dispensed by pharmacy), a canister 10 comprising a non-static desiccant material 18 and an activated electronic article surveillance radio frequency (EAS RF) tag 20, with an active element 220 (e.g. antenna) disposed between a GRAS qualified label and an anti-static release liner 200. The release liner 200 may be separated from the remaining elements (e.g. first layer 210, antenna 220, and second layer 230), with the layers 210, 230 and antenna 220 applied to the canister 10, and the canister 10 embedded with at least one moisture-sensitive article. The EAS system may further include at least one gate comprising a transmitter and receiver, the transmitter producing a signal across an interrogation zone, the receiver detecting the active device within the interrogation zone and generating an alarm message.

A process for monitoring moisture-sensitive articles includes the steps of embedding a desiccant canister 10 within a container retaining the moisture-sensitive articles (e.g. a pill bottle), the canister 10 comprising a non-static desiccant 18 and an activated electronic article surveillance radio frequency (EAS RF) tag 20 disposed between a GRAS qualified label and an anti-static release liner 200. The process includes the steps of establishing an interrogation zone adjacent to at least one exit, transmitting a signal across the interrogation zone, and detecting an active EAS RF device entering the interrogation zone.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

What is claimed is:

1. An anti-theft desiccant canister comprising:
a body;
a desiccant retained within the body; and
an electronic article surveillance radio frequency device that is embedded within a label applied to the body.

2. An anti-theft desiccant canister of claim 1, wherein said body is cylindrical.

3. An anti-theft desiccant canister of claim 1, wherein said desiccant comprises anti-static material.

4. An anti-theft desiccant canister of claim 1, wherein said label comprises a Generally Regarded AS Safe qualified label.

5. A system comprising:
a container retaining at least one moisture-sensitive article;
a canister comprising a desiccant material and an electronic article surveillance radio frequency device;
wherein said electronic article surveillance radio frequency device disposed between a label and a release liner, the label applied to the canister, the electronic article surveillance radio frequency device activated to emit an radio frequency signal for detection.

6. A system of claim 5, wherein said desiccant comprises anti-static material.

7. A system of claim 5, wherein said label comprises a Generally Regarded AS Safe qualified label.

8. An electronic article surveillance system comprising:
at least one moisture-sensitive article;
a canister comprising an anti-static desiccant material and an activated electronic article surveillance radio frequency device, said device disposed between a label and a release liner, said label applied to said canister, said canister embedded with the at least one moisture-sensitive article; and
an electronic article surveillance radio frequency detector monitoring at least one associated interrogation zone for a signal from said activated electronic article surveillance radio frequency device.

9. An electronic article surveillance system of claim 8, having at least one gate comprising a transmitter and receiver, said transmitter producing a signal across an interrogation zone, said receiver detecting said signal and generating an alarm message.

10. An electronic article surveillance system of claim 8, wherein said label comprises a Generally Regarded AS Safe qualified label.
